(19) United States
(12) Patent Application Publication
(10) Pub. No.: US 2009/0289855 A1
(43) Pub. Date: Nov. 26, 2009

(54) Methods and Apparatus for Providing an Integrated Inverted Loop Antenna in a Wireless Device

(75) Inventor: Jan-Willem Zweers, Nieuwleusen (NL)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/126,283

(22) Filed: May 23, 2008

(51) Int. Cl. H01Q 1/24; H01Q 1/42

(52) U.S. Cl. 343/702; 343/872

(57) ABSTRACT

An integral antenna for a wireless device in a personal article may include a housing that defines an interior space that is configured to house a functional component of the personal article. The housing includes an electrically conductive housing portion that is configured to include a first opening that substantially defines a first plane. The integral antenna includes an electrically conductive plane that is mounted in the interior space and is isolated from the electrically conductive housing portion, the electrically conductive plane oriented substantially parallel to and spaced apart from the first plane and defining a continuous gap between the electrically conductive plane and the electrically conductive housing portion.

### BACKGROUND

Portable and hand-held computing and communications devices with wireless communication capabilities may have signal transmission or reception issues depending, for example, on the relative sizes of the devices and/or the signal wavelengths used. Antennas of various types have been used with such devices. Such antennas have radiated or received electromagnetic signals with varying degrees of effectiveness depending upon the physical types, orientations, sizes and/or structural configurations of the antennas, particularly in view of the wavelengths of the signals to be transmitted or received.

Antennas have been provided inside small electronic devices, such as hand-held and/or wrist-won devices. Such antennas may experience performance difficulties when arranged inside a device housing, especially if the housing includes electrically conductive materials. Additionally, attempts at internally positioned antennas have included ceramic or dielectric loaded antennas. The high permittivity of the ceramic material permits miniaturization at sufficiently long electrical lengths. However, ceramic antennas may suffer from low efficiency and/or bandwidth and maybe highly sensitive to environmental conditions. Further, ceramic antennas may result in a high cost and/or high weight antenna.

Some attempts to provide wireless communication with small electronic devices, such as hand-held or wrist-top devices, may have used external loop antennas. In wristwatch type devices that include wireless communications abilities, loop antennas have been disposed as separate elongated loops in one or both sides of a watchband or as a continuous loop extending around the entire circumference of the watchband or watch face. Electromagnetic signal propagation may not be very efficient for the elongated loop antennas embedded in each wrist band side of dual sided watchband, such as is used with a common tongue buckle watchband. Such loop antennas may provide a small, weak radiation area and the direction of radiation can be limited as loop antennas typically provide radiation mostly normal to the loop, leaving large areas of little or no signal transmission or reception. Note also that tongue buckles may preclude the use of the loop antennas wrapping around the circumference of the wrist because the tongue fastener of such a buckle may not provide good continuous electrical contact when bringing and holding the two wristband side portions together.

Nevertheless, these configurations may have been used and may require a good mechanical buckling for creating an acceptable electrical contact with low losses across the buckle. Such mechanical buckling may be bulky, thus causing discomfort in use and a lack of visual appeal. Adjustability of such buckles has also been complicated.

In an attempt to address such limitations, wristwatch antennas have been incorporated in a watchband as a dipole antenna. However, reliance on a specific watchband for attenuation may reduce the desirability of a wristwatch since such a wristwatch may be limited to functionality only with specifically manufactured watchbands. Additionally, wristwatch antennas positioned within watchbands may be proximate the body of a user and thus may operate at a low efficiency level.

### SUMMARY

Embodiments according to the invention can provide methods and apparatus for providing an integral antenna for a wireless device in a personal article. Some embodiments of an antenna may include a housing that defines an interior space that is configured to house a functional component of the personal article, the housing including an electrically conductive housing portion that is configured to include a first opening that substantially defines a first plane in the electrically conductive housing portion. Some embodiments provide an electrically conductive plane that is mounted in the interior space and is isolated from the electrically conductive housing portion, the electrically conductive plane oriented substantially parallel to and spaced apart from the first plane and defining a continuous gap between the electrically conductive plane and the electrically conductive housing portion.

In some embodiments, the electrically conductive housing portion and the electrically conductive plane form an inverted loop antenna with frequency response characteristics defined by the dimensional characteristics corresponding to the continuous gap.

In some embodiments, the personal article includes a wrist watch, the housing includes a wristwatch housing and the functional component includes time and/or date watch components, personal communication components and/or a user interface component. In some embodiments, the electrically conductive plane includes a conductive layer that is applied to a circuit board (CB).

Some embodiments include an excitation contact conductively connected to the electrically conductive plane and the electrically conductive housing portion at a position that is proximate a perimeter of the first opening.

Some embodiments include a tuning circuit that is configured to tune an electrical signal response of the inverted loop antenna. In some embodiments, the housing further includes a non-conductive housing portion that is configured to be adjacent a user when the personal article is worn by the user and that is configured to engage the electrically conductive housing portion to define the interior space.

In some embodiments, the first opening includes a circumference corresponding to substantially half the wavelength of a resonant frequency of the antenna. In some embodiments, the antenna operates corresponding to at least one of the following communication standards: BlueTooth, UltraWideBand (UWB), WiFi (IEEE802.11a, b, g), WiMAX (IEEE802.16), ZigBee (IEEE802.15.4), Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS), among others.

Some embodiments of the present invention include methods of providing an antenna within an electrically conductive housing portion of a personal article that includes a substantially planar opening. Embodiments of such methods may include positioning an electrically conductive plane proximate the opening, the electrically conductive plane oriented substantially parallel to a plane defined by the substantially planar opening. In some embodiments, the electrically conductive housing portion includes a wristwatch housing.

Some embodiments include providing an excitation point that is conductively coupled to the electrically conductive housing portion and/or the electrically conductive plane proximate the substantially planar opening and providing antenna tuning circuitry that is conductively coupled to the antenna at the excitation point and that is configured to tune an electrical signal response of the antenna.

In some embodiments, positioning the electrically conductive plane includes applying a conductive layer to at least a portion of a circuit board (CB). Some embodiments include attaching an electrically non-conductive housing portion to the electrically conductive housing portion to define a housing interior and in a position that is configured to be adjacent a user when the personal article is worn by the user, where positioning the electrically conductive plane includes positioning the electrically conductive plane within the housing interior.

In some embodiments, positioning the electrically conductive plane includes positioning the electrically conductive plane substantially coaxially relative to the substantially planar opening. In some embodiments, the electrically conductive housing portion and the electrically conductive plane include an inverted loop antenna. Some embodiments provide that the substantially planar opening includes a circumference corresponding to substantially half the wavelength of a resonant frequency of the inverted loop antenna.

In some embodiments, the antenna operates according to at least one of the following communication standards: BlueTooth, UltraWideBand (UWB), WiFi (IEEE802.11a, b, g), WiMAX (IEEE802.16), ZigBee (IEEE802.15.4), Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS), among others.

Some embodiments of the present invention include an antenna integrated into a wristwatch. Some embodiments include an electrically conductive wristwatch housing portion that includes a substantially planar opening corresponding to a face of the wristwatch and an electrically conductive plane that is positioned in an interior space of the wristwatch and is isolated from the electrically conductive housing portion, the electrically conductive plane oriented substantially parallel to and spaced apart from the substantially planar opening and defining a continuous gap between the electrically conductive plane and the electrically conductive housing portion. Embodiments of an antenna may include an excitation point that is conductively coupled to the electrically conductive plane and the electrically conductive wristwatch housing portion via circuitry.

Some embodiments include electrically non-conducting means for engaging the electrically conductive wristwatch housing portion and defining a wristwatch interior and tuning circuitry conductively coupled to the electrically conductive plane and/or the electrically conductive wristwatch housing portion to tune an electrical signal response of the antenna. In some embodiments, the electrically non-conducting means comprises a back portion of the wristwatch and is configured to be in contact with a wrist of a user when worn by the user.

### BRIEF DESCRIPTION OF THE DRAWINGS

FIG. 1 is a diagram illustrating a wristwatch including an integral antenna and multiple wireless devices in communication therewith according to some embodiments of the invention.

FIGS. 2A and 2B are front schematic views of a wristwatch including an integral antenna with the watch movement and face installed and removed, respectively, according to some embodiments of the present invention.

FIG. 3 is a block diagram illustrating a partial, side cross-sectional view of a wristwatch having an integral antenna according to some embodiments of the present invention.

FIG. 4 is a block diagram illustrating a partial, front view of a wristwatch of FIG. 3.

FIG. 5 is a graph plotting experimental S-parameter magnitude data of an internally positioned L antenna and an integrated inverted loop antenna according to some embodiments of the present invention.

FIG. 6 is a block diagram illustrating a tuning circuit connected to an integral inverted loop antenna according to some embodiments of the present invention.

FIG. 7 is a block diagram illustrating operations for providing an antenna in a personal article including a conductive housing according to some embodiments of the present invention.

### DESCRIPTION OF EMBODIMENTS ACCORDING TO THE INVENTION

The invention is described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specific disclosure and will not be interpreted in an idealized or overly formal sense unless expressly so defined herein.

It should be emphasized that the term “comprises/comprising” when used in this specification is taken to specify the presence of stated features, integers, steps or components but does not preclude the presence or addition of one or more other features, integers, steps, components or groups thereof.

It will be understood that although the terms first and second may be used herein to describe various components these components should not be limited by these terms. These terms are only used to distinguish one component from another. Thus, for example, a first component discussed below could be termed a second component without departing from the teachings of the present invention.

It will be understood mobile terminals and/or wireless devices according to the invention may operate in any type of wireless communications network. In some embodiments according to the invention, for example, the network may provide services broadly labeled as PCS (Personal Communications Services) including advanced digital cellular systems conforming to standards such as IS-136 and IS-95, lower-power systems such as DECT (Digital Enhanced Cordless Telephone), data communications services such as CDPD (Cellular Digital Packet Data), and other systems such as CDMA-2000, that are proposed using a format commonly referred to as Wideband Code Division Multiple Access (WCDMA).

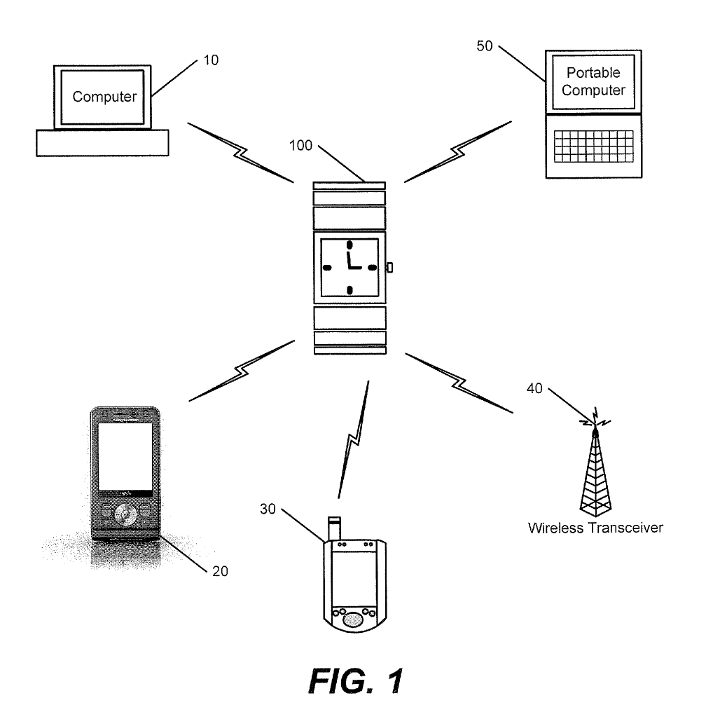

Reference is briefly made to FIG. 1, which is a diagram illustrating a wristwatch including an integral antenna and multiple wireless devices in communication therewith according to some embodiments of the invention. A wristwatch 100 includes wireless communication functionality and an integrated, inverted loop antenna that may receive and/or transmit electromagnetic waves. In some embodiments, the wristwatch 100 may communicate with other devices within a local area network, such as, for example, a personal area network and/or other communication wireless network. In some embodiments, the wristwatch 100 may communicate with devices in a point-to-point fashion across an air-interface absent any other network components.

In some embodiments, the wristwatch 100 may radiate signals to and/or receive signals from, and thus communicate with a wireless transceiver 40, and/or communicate with other electronic devices through wireless means, such as, BlueTooth, UltraWideBand (UWB), WiFi (IEEE802.11a, b, g), WiMAX (IEEE802.16), ZigBee (IEEE802.15.4), Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS), among others. Such other electronic devices may include, without limitation, a stationary computer 10, a portable computer 40, a wireless mobile terminal such as a cell phone 20, and/or a personal data assistant (PDA) 30, among others. Note that operational systems and/or environments utilizing an antenna according to embodiments described herein are not intended to limit the scope, use and/or functionality of the apparatus and/or methods disclosed herein. For example, although embodiments herein include a wristwatch, apparatus and methods herein may be applicable to other personal articles that may include an electrically conductive housing portion.

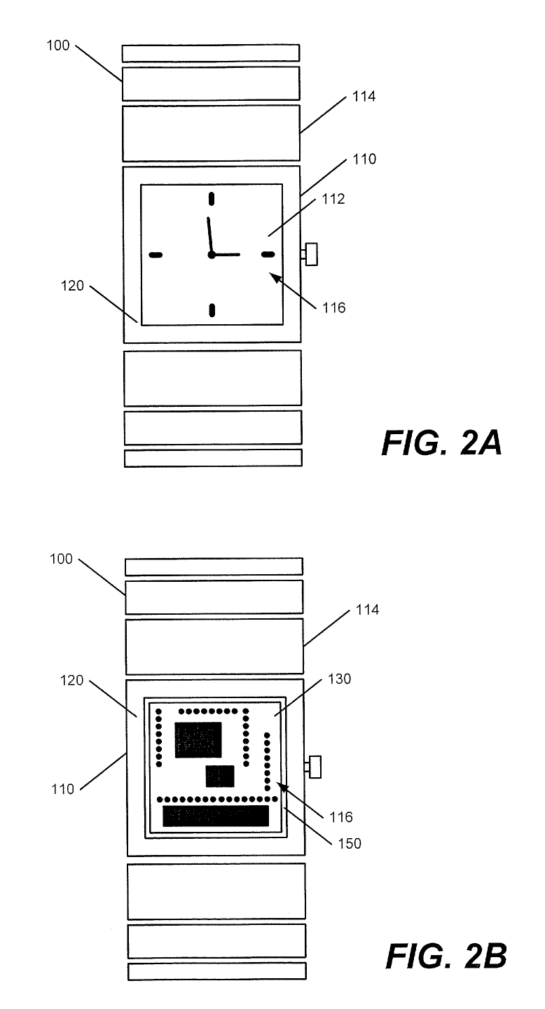

Reference is now made to FIGS. 2A and 2B, which are front schematic views of a wristwatch 100 including an integral antenna with the watch movement and face installed and removed, respectively, according to some embodiments of the present invention. In some embodiments, the wristwatch 100 includes a watchband 114 that is attached to the watch housing 110 and may be configured to maintain the wristwatch 100 position relative to the wrist of a wearer. Although illustrated as a metallic and/or conductive watchband 114, embodiments herein are not so limited. For example, as the antenna does not reside in or on the watchband 114, the type and/or presence of the watchband 114 is not relevant except, for example, in tuning one or more performance characteristics of the integral antenna.

As illustrated in FIG. 2A, the wristwatch 100 may include a functional component 112 that may be unrelated to wireless communications and/or an operation of the integral antenna. In some embodiments, the functional component 112 may include temporal information providing components such as a watch movement, face and/or circuit, among others. Some embodiments provide that the watch housing 110 may include an electrically conductive housing portion 120 that includes an opening 116 through which the functional component 112 may be viewed during normal use and operation.

In some embodiments, a wristwatch may include functional components 112 that provide communication related data, such as arrival and/or sender information regarding a received communication. Some embodiments provide that the functional components 112 may include, for example, a display such as a mirrored organic light emitting diode (OLED) display, among others. In some embodiments, functional component 112 may include one or more user interface components corresponding to, for example, other wireless device functions, such as, audio playback, among others.

Referring to FIG. 2B, behind the functional component 112, the watch housing 110 may define an interior space in which a printed circuit board (PCB) 130 may be provided that includes components related to wireless communication functionality, among others. The PCB 130 may include a conductive plane (not illustrated in this view) that may, in combination with the electrically conductive housing portion 120 and the opening 116 therein, form an inverted loop antenna. As is known, a loop antenna may include an electrically conductive material generally configured to form a loop. An inverted loop antenna as disclosed herein may be formed by the gap 150 formed between the opening 116 of the electrically conductive housing portion 120 and the conductive plane that may be provided on the PCB 130. By using the opening 116 of the electrically conductive housing portion 120 as a component of an antenna, reductions in performance corresponding to other types of internally located antennas may be avoided.

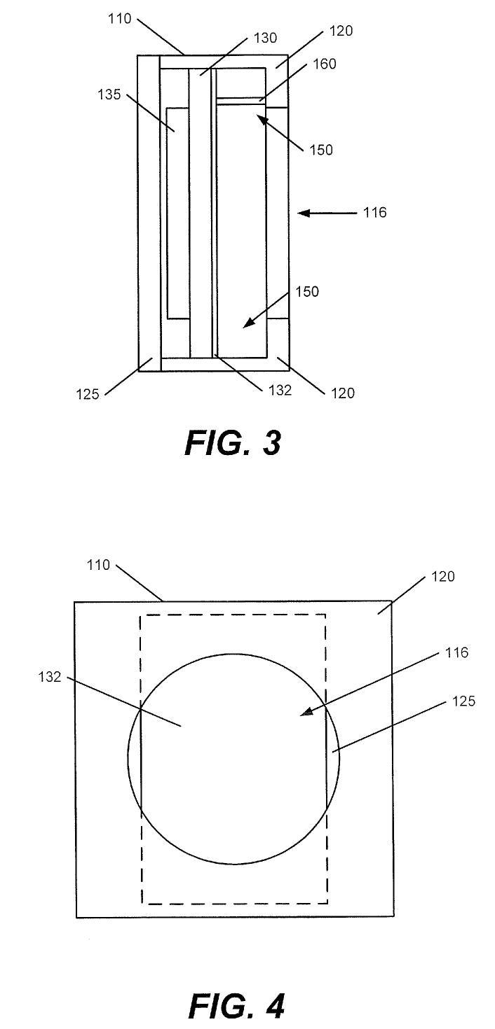

Reference is now made to FIG. 3, which is a block diagram illustrating a partial, side cross-sectional view of a wristwatch having an integral antenna according to some embodiments of the present invention. Although embodiments provided herein may be discussed in the context of a wristwatch, apparatus and methods herein may be applicable to a variety of personal articles that present challenges corresponding to providing an internal antenna. The wristwatch includes a watch housing 110, that is configured to define an interior space into which the functional components may be arranged. The housing 110 may include an electrically conductive housing portion 120 that may include an opening 116 through which the functional components may be visually accessed by a user. The opening 116 may include a substantially circular, elliptical and/or polygonal shape, among others.

A circuit board (CB) 130 may be mounted in the interior space of the watch housing 110. In some embodiments, the CB may include a printed circuit board (PCB). Some embodiments provide that an electrically conductive plane 132 is formed on and/or attached to the CB 130. In some embodiments, the electrically conductive plane 132 may include a ground plane that is formed on and/or attached to the CB 130. In some embodiments, the electrically conductive plane 130 may be isolated from the electrically conductive housing portion 120. Some embodiments provide that the electrically conductive plane 130 may be oriented substantially parallel to a plane that is substantially defined by the opening 116. In some embodiments, the electrically conductive plane 130 is spaced apart from the electrically conductive housing portion 120 such that a continuous gap 150 may be defined.

The continuous gap 150 defined between the electrically conductive plane 130 and the electrically conductive housing portion 120 may function as an inverted loop antenna. In some embodiments, the inverted loop antenna may include performance characteristics corresponding to those of a loop antenna including dimensional characteristics corresponding to the continuous gap 150. In this manner, instead of trying to overcome antenna performance related challenges presented by the electrically conductive housing portion 120, the electrically conductive housing portion 120 may be included as a component of an inverted loop antenna.

An excitation point 160 may be provided to conductively engage the electrically conductive plane 130 and/or the electrically conductive housing portion 120. Some embodiments provide that a plurality of excitation points 160 may be provided at a variety of points on the electrically conductive plane 130 and/or the electrically conductive housing portion 120. In some embodiments, the excitation point 160 may be connected proximate the perimeter of the opening 116. Some embodiments provide that the opening 116 includes a circumference that is approximately half the wavelength of an electromagnetic signal at the resonant frequency of the antenna.

In some embodiments, the antenna may include a tuning circuit (not shown). Some embodiments provide that the tuning circuit may be electrically coupled across, between and/or to the excitation point, the electrically conductive plane 130 and/or the electrically conductive housing portion 120. Some embodiments provide that the tuning circuit may be configured to tune the electrical length and/or the electrical signal response of the inverted loop antenna. By tuning the electrical signal response of the antenna, parameters such as, for example, resonant frequency and/or impedance of the antenna, among others, may be adjusted. In this manner, the performance of the antenna may be adjusted to optimize performance corresponding to different configurations, environments, and/or applications. For example, an antenna in a wristwatch that includes an electrically conductive watch band may be tuned differently that an antenna used in combination with a non-conductive watch band.

Some embodiments provide that the watch housing 110 may include a non-conductive housing portion 125. The non-conductive housing portion 125 may be configured to engage the electrically conductive housing portion 120 to define the interior space. The interior space may be configured to receive and/or house the functional components, the PCB 130, and/or a battery 135 that may store energy for the operation of the functional components and/or circuits on the PCB 130, among others.

In some embodiments, the antenna is configured to receive and/or transmit signals according to least one of multiple communication standards including BlueTooth, UltraWideBand (UWB), WiFi (IEEE802.11a, b, g), WiMAX (IEEE802.16), ZigBee (IEEE802.15.4), Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS), among others.

Brief reference is made to FIG. 4, which is a block diagram illustrating a partial, front view of a wristwatch of FIG. 3. In some embodiments, the watch housing 110 includes an electrically conductive housing portion 120 that includes an opening 116 through which visual access to functional components (not shown) therein may be visually accessed. A non-conductive housing portion 125 may engage the electrically conductive housing portion to define an interior space. An electrically conductive plane 132 may be positioned within the interior space.

The electrically conductive plane 132 may be substantially parallel to the opening 116 and may be electrically engaged, along with the electrically conductive housing portion 120, to function as an inverted loop antenna. Specifically, the inverted term refers to the concept wherein the antenna performs like a loop antenna that would include dimensions consistent with the dimensions of the gap between the electrically conductive housing portion 125 and the electrically conductive plane 132

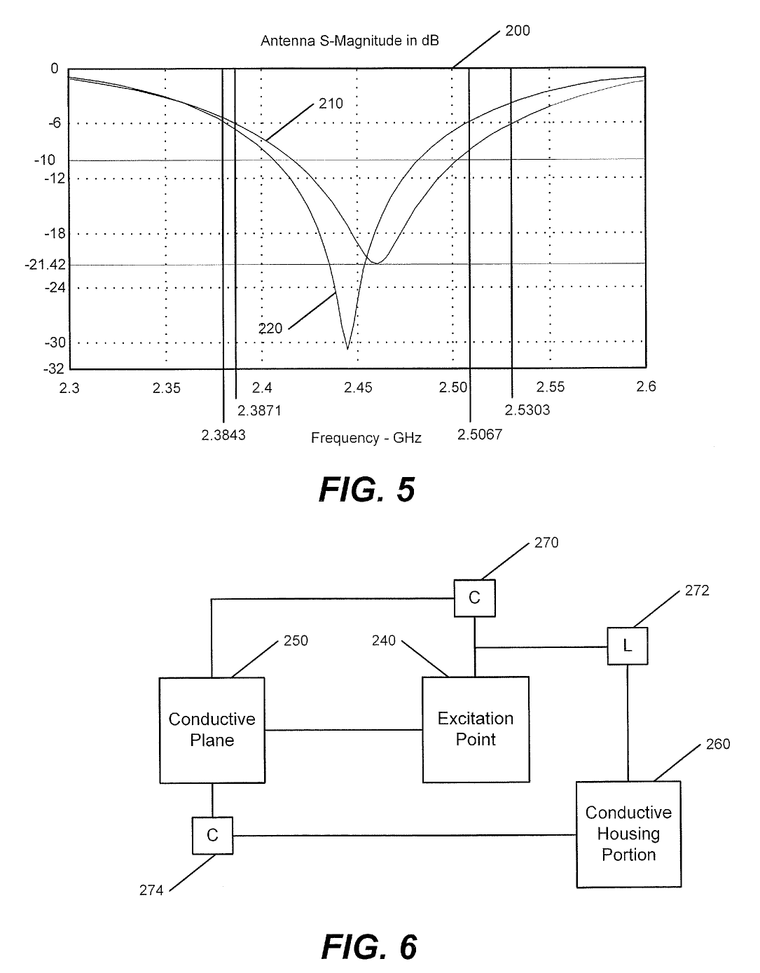

Reference is now made to FIG. 5, which is a graph 200 plotting experimental S-parameter magnitude data that may be obtained for an internally positioned L antenna and an integrated inverted loop antenna according to some embodiments of the present invention. The graph 200 includes experimental S-parameter data expressed in dB plotted as a function of frequency in a 2.3 to 2.6 GHz range. S-parameters are properties used to describe electrical behavior in linear electrical networks when undergoing various steady state stimuli by small signals. The S-parameters may be used in networks operating a radio frequency (RF) and microwave frequencies where signal and energy considerations may be more easily quantified than currents and voltages. The L antenna curve 220 represents simulated data corresponding to an L-shaped antenna inside a watch housing. Note that the −6 dB crossing frequencies are identified as 2.3843 GHz and 2.5067 GHz. In this regard, the bandwidth may be represented as the difference between the −6 dB crossing frequencies, which is 122.4 Mhz.

In comparison, the inverted loop antenna curve 210 represents simulated data that may be obtained for an inverted loop antenna integrated into the watch housing. The −6 dB crossing frequencies are identified as 2.3871 GHz and 2.5303 GHz. In this regard, the bandwidth may be represented as the difference between the −6 dB crossing frequencies, which is 143.2 MHz. Note that the inverted loop antenna may provide better than a 17% increase in bandwidth. Increases in bandwidth may provide a more robust antenna that may be more easily tuned to accommodate diverse communication environments. In addition to improvements in bandwidth, an inverted loop antenna may provide significant increases in antenna efficiency. The efficiency of an antenna may be described as the fraction of the energy applied to the antenna that is actually radiated from the antenna. In some embodiments, an inverted loop antenna as described herein may experience efficiency levels that are improved by factors of two or more. In some embodiments, efficiency may be improved by a factor of five or more by improving from a −15 dB to a −8 dB efficiency. In terms of percent efficiencies, these gains may translate into 3% and 16% efficiencies, respectively. The efficiencies described herein correspond to near body efficiencies, which may be significantly less than efficiencies realized in free space. For example, an inverted loop antenna as described herein may perform at a −2 dB efficiency in free space, which may translate to approximately 63% efficiency.

Reference is now made to FIG. 6, which is a block diagram illustrating a tuning circuit connected to an integral inverted loop antenna according to some embodiments of the present invention. As discussed herein an inverted loop antenna may be provided in a personal article housing via a gap between a conductive housing portion 260 having an opening and a conductive plane 250 that is positioned offset from and substantially parallel to a plane defined by the opening.

An excitation point 240 may be provided for sending and/or receiving electrical currents corresponding to the electromagnetic waves to be received and/or transmitted by the inverted loop antenna. Some embodiments may include more than one excitation points for sending and/or receiving electrical currents corresponding to electromagnetic waves. In some embodiments, an antenna shunt capacitor 274 may be interconnected between the conductive plane 250 and the conductive housing portion 260. Some embodiments provide that a source shunt capacitor 270 may be provided between the conductive plane 250 and the excitation point 240. In some embodiments, a series inductor 272 may be provided between the excitation point 240 and the conductive housing portion 272. Exemplary values of the antenna shunt capacitor 274, the source shunt capacitor 270 and the series inductor 272 may include 1.6 pf, 0.1 pf, and/or 7 nH, among others. In some embodiments, the capacitor and/or inductor values may be selected and/or adjusted to provide different antenna impedance, electrical length, bandwidth, and/or resonant frequency characteristics, among others. The impedance matching circuits described herein are merely exemplary and such may be implemented in a variety of combinations of transmission lines, capacitors, inductors, resistors, active components, transistors, and/or transformers, among others.

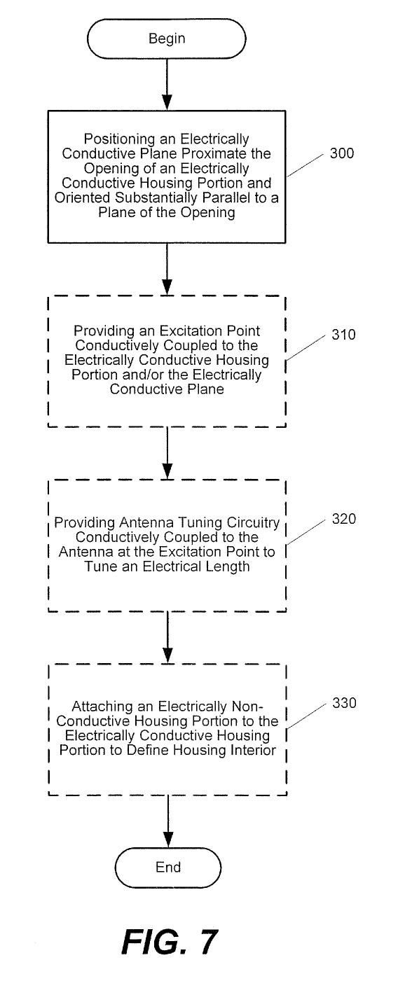

Reference is now made to FIG. 7, which is a block diagram illustrating operations for providing an antenna in a personal article including a conductive housing according to some embodiments of the present invention. Some embodiments include positioning an electrically conductive plane proximate an opening of an electrically conductive housing portion of a personal article (block 300). Some embodiments provide that the electrically conductive plane is positioned substantially parallel to a plane defined by the opening in the electrically conductive housing portion. In some embodiments, the electrically conductive plane may be offset from the opening and may be positioned in an interior space that is defined, in part, by the electrically conductive housing portion.

Operations according to some embodiments may include providing an excitation point that is conductively coupled to the electrically conductive housing portion and/or the electrically conductive plane (block 310). In this manner, the currents circulating through the electrically conductive plane and/or the electrically conductive housing portion may be provided and/or received by communication circuitry. Some embodiments include providing antenna tuning circuitry that is conductively coupled to the antenna at the excitation point to tune an electrical length of the antenna (block 320). In some embodiments, antenna tuning circuitry may include passive and/or active electronic and/or integrated circuit components, including, for example, resistors, capacitors, inductors, and/or transistors, among others.

In some embodiments, positioning the electrically conductive plane may include applying a conductive layer to at least a portion of a printed circuit board (PCB). In some embodiments, positioning the electrically conductive plane includes positioning the electrically conductive plane substantially coaxially relative to the substantially planar opening. Some embodiments provide that the substantially planar opening includes a circumference corresponding to substantially one half of the wavelength of an electromagnetic wave including a frequency that is substantially the same as a resonant frequency of the inverted loop antenna.

Some embodiments of operations include attaching an electrically non-conductive housing portion to the electrically conductive housing portion to define a housing interior in a position that is configured to be adjacent a user when the personal article is worn (block 330). In some embodiments, the electrically conductive plane may be positioned within the housing interior.

In some embodiments, the antenna operates according to at least one of BlueTooth, UltraWideBand (UWB), WiFi (IEEE802.11a, b, g), WiMAX (IEEE802.16), ZigBee (IEEE802.15.4), Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS), among others.

In the drawings and specification, there have been disclosed embodiments of the invention and, although specific terms are employed, they are used in a generic and descriptive sense only and not for purposes of limitation, the scope of the invention being set forth in the following claims.

What is claimed:

1. An integral antenna for a wireless device in a personal article, the antenna comprising:
a housing that defines an interior space that is configured to house a functional component of the personal article, the housing comprising an electrically conductive housing portion that is configured to include a first opening that substantially defines a first plane in the electrically conductive housing portion; and
an electrically conductive plane that is mounted in the interior space and is isolated corresponding to at least one specific radio frequency from the electrically conductive housing portion, the electrically conductive plane oriented substantially parallel to and spaced apart from the first plane and defining a continuous gap between the electrically conductive plane and the electrically conductive housing portion.

2. The antenna of claim 1, wherein the electrically conductive housing portion and the electrically conductive plane form an inverted loop antenna with frequency response characteristics defined by the dimensional characteristics corresponding to the continuous gap.

3. The antenna of claim 1, wherein the personal article comprises a wrist watch, wherein the housing comprises a wristwatch housing and wherein the functional component comprises time and/or date watch components, personal communication components and/or a user interface component.

4. The antenna of claim 1, wherein the electrically conductive plane comprises a conductive layer that is attached to a circuit board (CB).

5. The antenna of claim 1, further comprising an excitation contact conductively connected to the electrically conductive plane and the electrically conductive housing portion at a position that is proximate a perimeter of the first opening.

6. The antenna of claim 1, further comprising a tuning circuit that is configured to tune an electrical signal response of the inverted loop antenna.

7. The antenna of claim 1, wherein the housing further comprises a non-conductive housing portion that is configured to be adjacent a user when the personal article is worn by the user and that is configured to engage the electrically conductive housing portion to define the interior space.

8. The antenna of claim 1, wherein the first opening comprises a circumference corresponding to substantially half the wavelength of a resonant frequency of the antenna.

9. The antenna of claim 1, wherein the antenna operates corresponding to at least one of the following communication standards: BlueTooth, UltraWideBand (UWB), WiFi (IEEE802.11a, b, g), WiMAX (IEEE802.16), ZigBee (IEEE802.15.4), Global Standard for Mobile (GSM) communication, General Packet Radio Service (GPRS), enhanced data rates for GSM evolution (EDGE), Integrated Digital Enhancement Network (iDEN), code division multiple access (CDMA), wideband-CDMA, CDMA2000, and/or Universal Mobile Telecommunications System (UMTS).

10. A method of providing an antenna within an electrically conductive housing portion of a personal article that includes a substantially planar opening, the method comprising:
positioning an electrically conductive plane proximate the opening, the electrically conductive plane oriented substantially parallel to a plane defined by the substantially planar opening.

11. The method of claim 10, wherein the electrically conductive housing portion comprises a wristwatch housing.

12. The method of claim 10, further comprising:
providing an excitation point that is conductively coupled to the electrically conductive housing portion and/or the electrically conductive plane proximate the substantially planar opening; and
providing antenna tuning circuitry that is conductively coupled to the antenna at the excitation point and that is configured to tune an electrical signal response of the antenna.

13. The method of claim 10, wherein positioning the electrically conductive plane comprises applying a conductive layer to at least a portion of a circuit board (CB).

14. The method of claim 10, further comprising:
attaching an electrically non-conductive housing portion to the electrically conductive housing portion to define a housing interior and in a position that is configured to be adjacent a user when the personal article is worn by the user, where positioning the electrically conductive plane comprises positioning the electrically conductive plane within the housing interior.

15. The method of claim 10, wherein positioning the electrically conductive plane comprises positioning the electrically conductive plane substantially coaxially relative to the substantially planar opening.

16. The method of claim 10, wherein the electrically conductive housing portion and the electrically conductive plane comprise an inverted loop antenna.

17. The method of claim 16, wherein the substantially planar opening comprises a circumference corresponding to substantially half the wavelength of an electromagnetic wave including a resonant frequency of the inverted loop antenna.

18. An antenna integrated into a wristwatch, the antenna comprising:
an electrically conductive wristwatch housing portion that includes a substantially planar opening corresponding to a face of the wristwatch;
an electrically conductive plane that is positioned in an interior space of the wristwatch and is isolated from the electrically conductive housing portion, the electrically conductive plane oriented substantially parallel to and spaced apart from the substantially planar opening and defining a continuous gap between the electrically conductive plane and the electrically conductive housing portion; and
an excitation point that is conductively coupled to the electrically conductive plane and the electrically conductive wristwatch housing portion via circuitry.

19. The antenna of claim 18 further comprising:
electrically non-conducting means for engaging the electrically conductive wristwatch housing portion and defining a wristwatch interior; and
tuning circuitry conductively coupled to the electrically conductive plane and/or the electrically conductive wristwatch housing portion to tune an electrical length of the antenna.

20. The antenna of claim 19, wherein the electrically non-conducting means comprises a back portion of the wristwatch and is configured to be in contact with a wrist of a user when worn by the user.
